(19) United States
(12) Patent Application Publication
(10) Pub. No.: US 2016/0371373 A1
(43) Pub. Date: Dec. 22, 2016

(54) Digital Media Content and Associated User Pool Apparatus and Method

(71) Applicant: CROWDMIX LTD, Nottingham (GB)

(72) Inventors: Andy DEAN, London (GB); Ben Wolff, London (GB)

(21) Appl. No.: 15/117,431

(22) PCT Filed: Feb. 4, 2015
(86) PCT No.: PCT/CN2015/072262

§ 371 Date: Aug. 8, 2016

(30) Foreign Application Priority Data
Feb. 7, 2014 (GB) 1402190.1

(51) Int. Cl. G06F 17/30

(52) U.S. Cl. CPC G06F 17/30766; G06F 17/30029; G06F 17/3005; G06F 17/30769; H04L 67/22

(57) ABSTRACT

A dynamic digital media content pool apparatus and method comprising access to a plurality of digital media content libraries of associated users. A dynamic digital media content pool apparatus comprising a communication interface arranged to receive digital media content data from a plurality of user devices; a digital media store for storing the digital media content data from the plurality of user devices; a registration module for configuring the digital media content data according to an association indicator representing an association between at least two users; and an analysis module for generating a search result of the digital media content data based on a relevant context of the user digital media content data associated with the association indicator.

### TECHNICAL FIELD

The present invention relates to digital media content libraries, and more specifically to a dynamic digital media content pool apparatus and method comprising access to a plurality of digital media content libraries of associated users.

### BACKGROUND ART

Known systems for automatically generating a playlist of digital audio tracks traditionally access a user's existing digital audio track libraries that are arranged by artist, title, date, genre, etc. A playlist is typically generated from a selected song with collaborative filtering and ranking algorithms that base the recommended mixed playlist on similar music artist and genre. This often results in a randomly compiled set of audio tracks that are meaningless to the user. Attempts have been made to improve the automatically generated playlists by searching multiple users' digital audio track libraries to increase the amount data and diversity of the audio tracks. However, the resulting automatically generated playlists from such traditional systems are often incompatible or clash with the user's musical tastes and remain meaningless to the user.

There is a need for a dynamic digital media content apparatus and method for automatically generating playlists of digital media content that are more likely to be in keeping with the user's preferences and thus more meaningful to a user.

### DISCLOSURE OF INVENTION

### Solution to Problem

### Technical Solution

An aspect of the invention is a digital media content pool apparatus comprising: a communication interface arranged to receive digital media content data from a plurality of user devices; a digital media store for storing the digital media content data from the plurality of user devices in one or more digital media content pools; a registration module for configuring the digital media content data in one or more of the digital media content pools according to an association marker representing an association between at least two users; and an analysis module for generating a search result of the digital media content data in one or more of the digital media content pools in response to a search request from a requesting user device based on a relevant context of the user digital media content data associated with the association marker and the type of content requested and information associated with the user of the requesting user device.

In an embodiment, the search request may be generated in response to a user action on a user device.

In an embodiment, the user action may comprise playing a specific digital media content data.

In an embodiment, the search request may be generated in response to a change in the digital media content data of the digital media store.

In an embodiment, the search request may be generated in response to a change in the digital media content data of the user device.

In an embodiment, the association marked may comprise a music concert event.

In an embodiment, the registration module may be arranged to configure the digital media content data according to a plurality of association markers.

In an embodiment, the plurality of association markers may comprise a primary association marker being associated with users having an association marker in common with the user in which the search is based.

In an embodiment, the plurality of association markers may comprise a secondary association marker wherein the secondary association marker comprises at least one association marker different from the primary association marker.

In an embodiment, the plurality of association markers may comprise a secondary association marker being associated with users having an association marker uncommon with the user in which the search is based.

In an embodiment, the plurality of association markers may comprise a tertiary association marker being associated with a feature of the digital media content data in common with the relevant context of the requested digital media content data of the user in which the search is based.

In an embodiment, the feature of the digital media content data may comprise the genre of the requested digital media content data.

In an embodiment, the feature of the digital media content data may comprise a support artist of the artist of the requested digital media content data.

In an embodiment, the plurality of association markers may comprise at least one primary association marker, at least one secondary association marker, and at least one tertiary association marker.

In an embodiment, the search result may comprise user details associated with the digital media content data.

In an embodiment, the digital media content data from the user device may be updated and stored in the media store in response to a registration of a user.

In an embodiment, the digital media content data from the user device may be updated and stored in the media store in response to a search request.

In an embodiment, the digital media content data from the user device may be updated and stored in the media store in response to a change in the digital media content data on the user device.

In an embodiment, the search result may be stored in the media store and compared with another previous search result stored in the media store associated with the user in which the search is based, and the search result is altered if the search result is identical to a previous search result.

In an embodiment, the digital media content data may comprise features for tracking user actions corresponding with the digital media content data.

In an embodiment, the search result may be based on weighted factors of the digital media content data.

An aspect of the invention is a digital media content pool method comprising: receiving digital media content data from a plurality of user devices; storing the digital media content data from the plurality of user devices in one or more digital media content pools; configuring the digital media content data in one or more of the digital media content pools according to an association marker representing an association between at least two users; and generating a search result of the digital media content data in one or more of the digital media content pools in response to a search request from a requesting user device based on a relevant context of the user digital media content data associated with the association marker and the type of content requested and information associated with the user of the requesting user device.

The digital media content pool method may comprise generating the search request in response to a user action on a user device.

The user action may play a specific digital media content data.

The method may generate the search request in response to a change in the digital media content data of the digital media store.

The method may comprise generating the search request in response to a change in the digital media content data of the user device.

The association marker may be a music concert event.

The method may comprise configuring the digital media content data according to a plurality of association markers.

An aspect of the invention is a digital media content pool server comprising: a communication interface arranged to receive digital media content data from a plurality of user devices;a digital media store for storing the digital media content data from the plurality of user devices in one or more digital media content pools; a registration module for configuring the digital media content data in one or more of the digital media content pools according to an association marker representing an association between at least two users; and an analysis module for generating a search result of the digital media content data in one or more of the digital media content pools in response to a search request from a requesting user device based on a relevant context of the user digital media content data associated with the association marker and the type of content requested and information associated with the user of the requesting user device.

An aspect of the invention is a computer system for a dynamic digital media content pool, the computer system comprising: a communication interface arranged to receive digital media content data from a plurality of user devices; a digital media store for storing the digital media content data from the plurality of user devices in one or more digital media content pools; a registration module for configuring the digital media content data in one or more of the digital media content pools according to an association marker representing an association between at least two users; and an analysis module for generating a search result of the digital media content data in one or more of the digital media content pools in response to a search request from a requesting user device based on a relevant context of the user digital media content data associated with the association marker and the type of content requested and information associated with the user of the requesting user device.

An aspect of the invention is a computer readable medium comprising computer readable code for a dynamic media content pool apparatus, server or computer system, the computer readable code for performing the steps of the method of the invention.

### BRIEF DESCRIPTION OF DRAWINGS

### Description of Drawings

Embodiments of the invention will now be described, by way of example only, with reference to the accompanying drawings. The invention is diagrammatically illustrated by way of example, in the accompanying drawings in which:

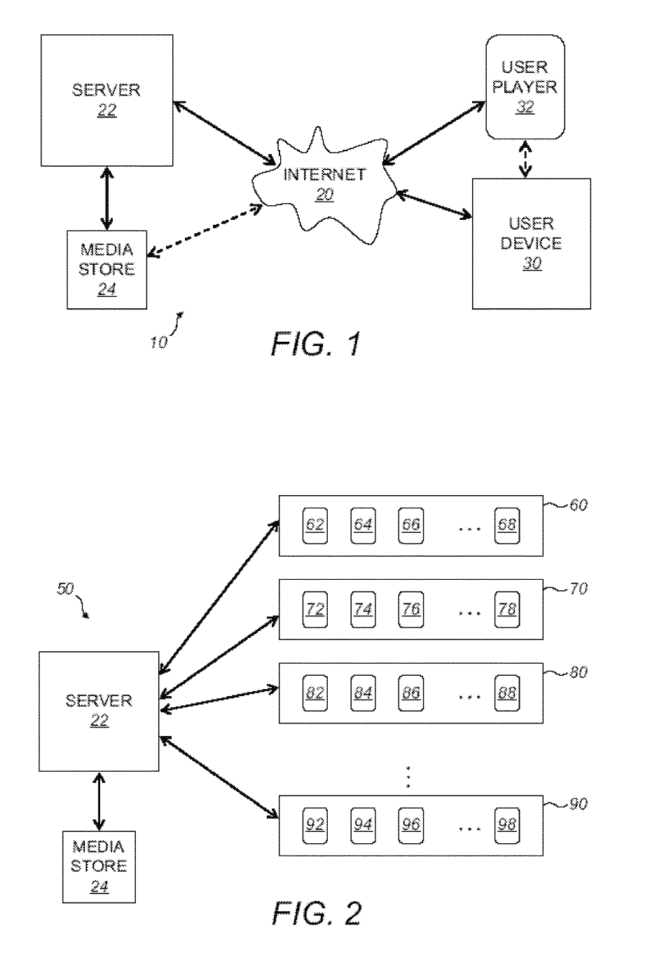

FIG. 1 illustrates a schematic block diagram overview of a network for associated user digital media content distribution in which a digital media content pool apparatus and method may be implemented in accordance with an embodiment of the invention;

FIG. 2 illustrates a representative schematic block diagram of data acquisition of associated user digital media content within the network shown in FIG. 1 in accordance with an embodiment of the invention;

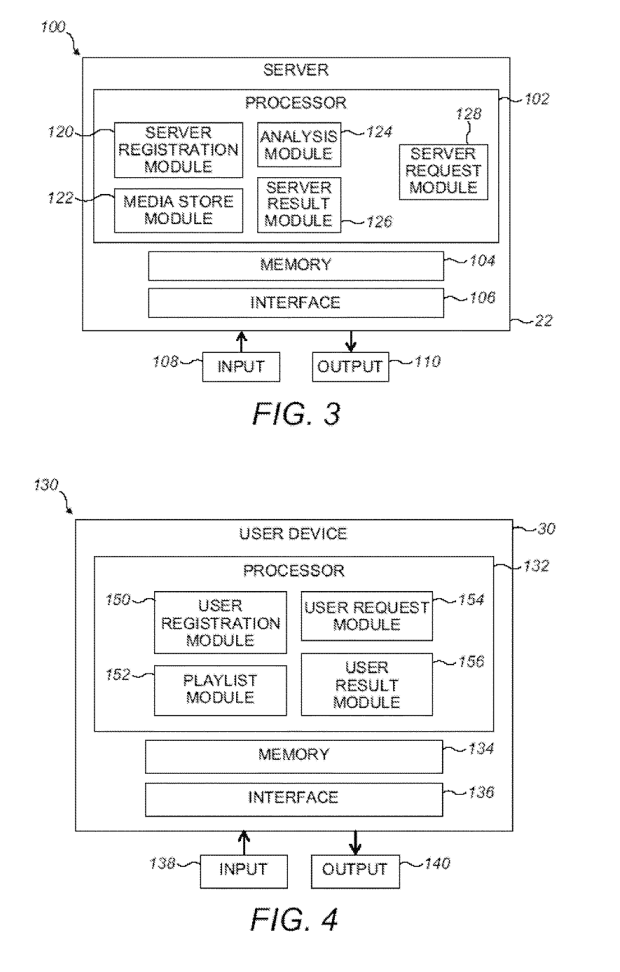

FIG. 3 illustrates a representative schematic block diagram of a server within the network shown in FIG. 1 in accordance with an embodiment of the invention;

FIG. 4 illustrates a representative schematic block diagram of a user device within the network shown in FIG. 1 in accordance with an embodiment of the invention;

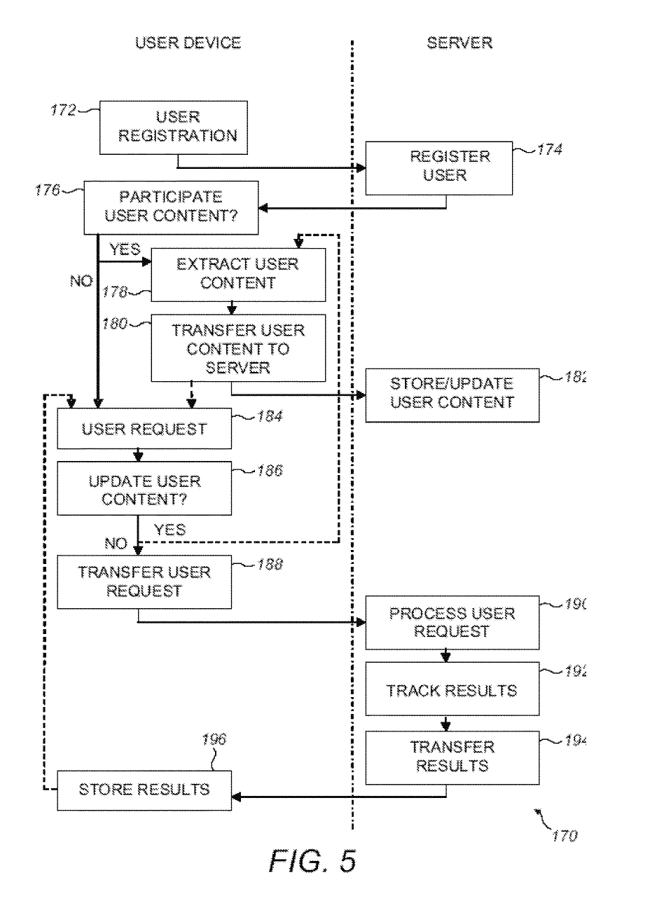

FIG. 5 illustrates a method of a digital media content user associated pool system in accordance with an embodiment of the invention;

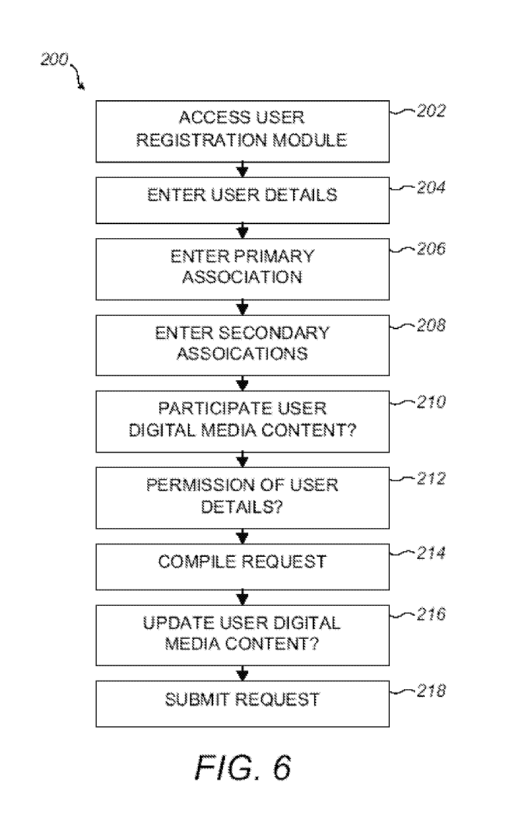

FIG. 6 illustrates a method of a module of the user device of FIG. 5 in more detail in accordance with an embodiment of the invention;

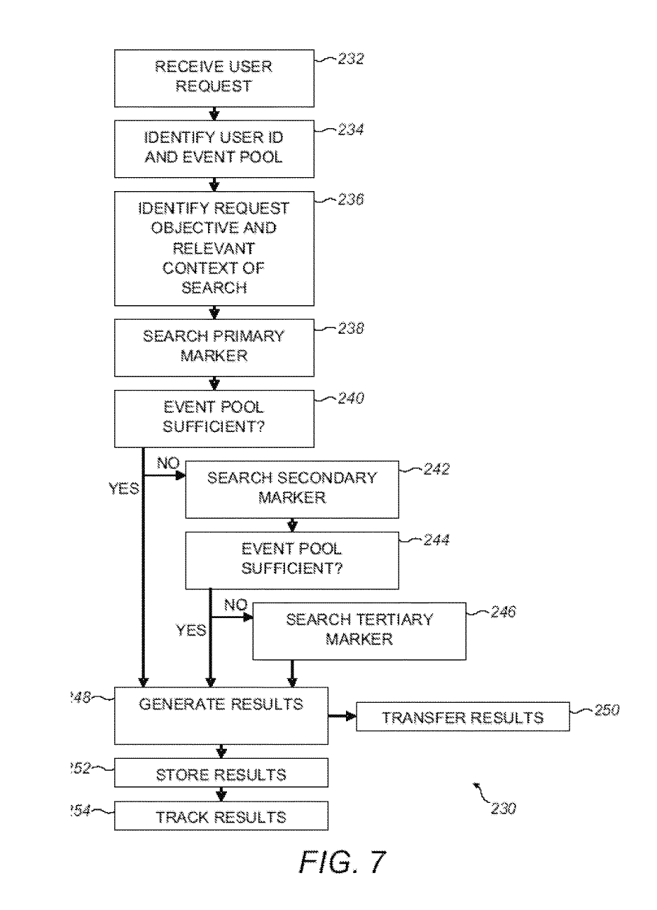

FIG. 7 illustrates a method of a module of the server of FIG. 5 in more detail in accordance with an embodiment of the invention;

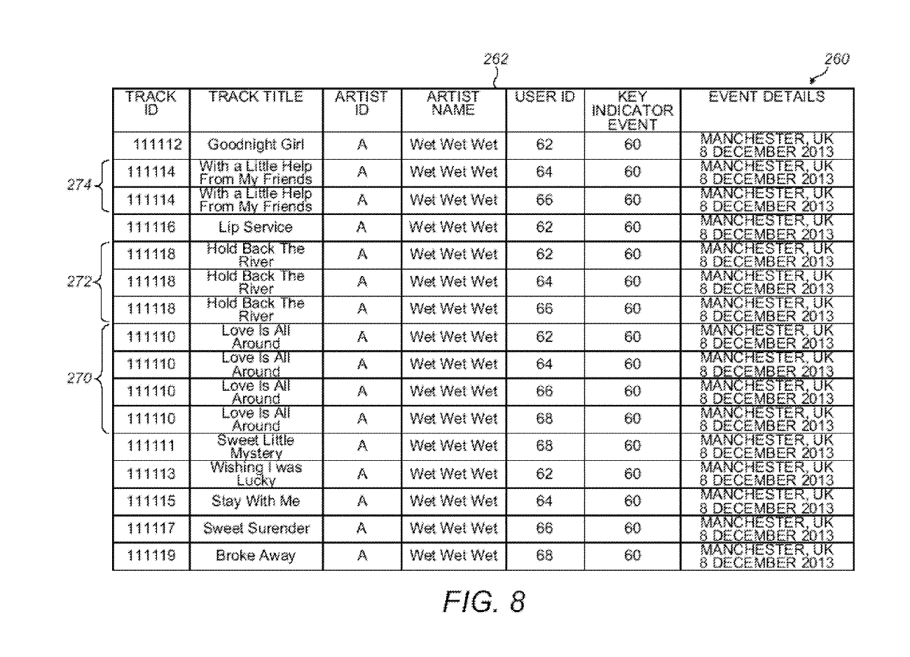

FIG. 8 is a table showing results of a user request for digital media content of an artist associated to the pool including a primary marker analysis in accordance with an embodiment of the invention;

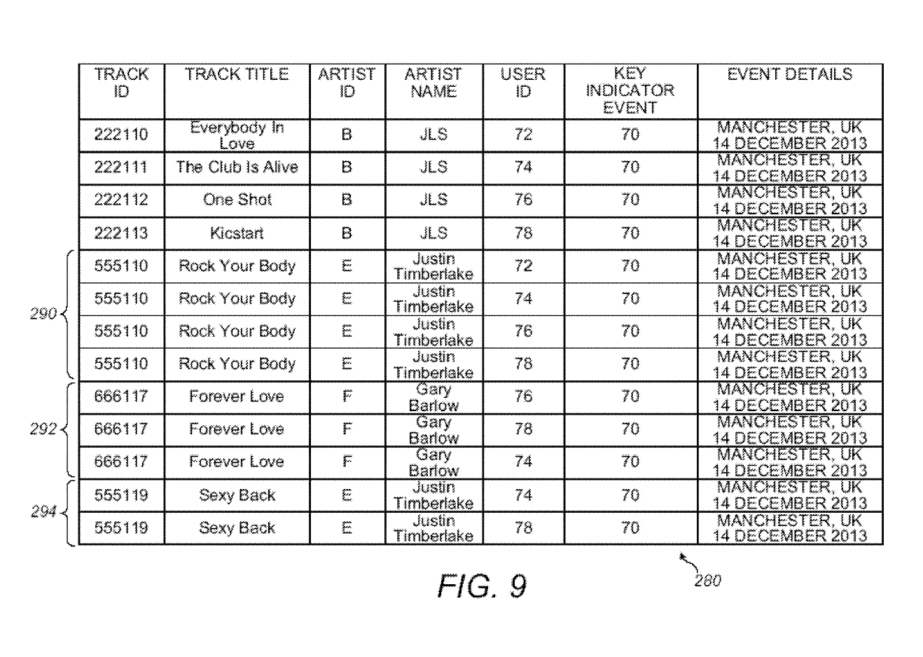

FIG. 9 is a table showing results of a user request for digital media content of an artist not associated to the pool including a primary marker analysis in accordance with an embodiment of the invention;

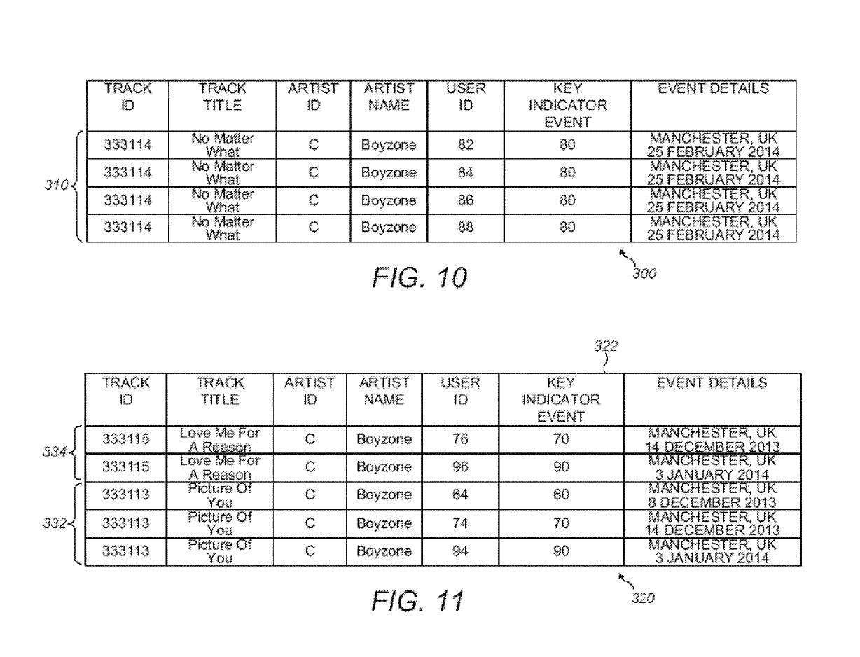

FIG. 10 is a table showing insufficient results of a user request of digital media content of an artist associated to the pool with an analysis including a primary marker in accordance with an embodiment of the invention;

FIG. 11 is a table showing results of a user request of digital media content pool with an analysis extending the digital media content pool to include a secondary marker in accordance with an embodiment of the invention;

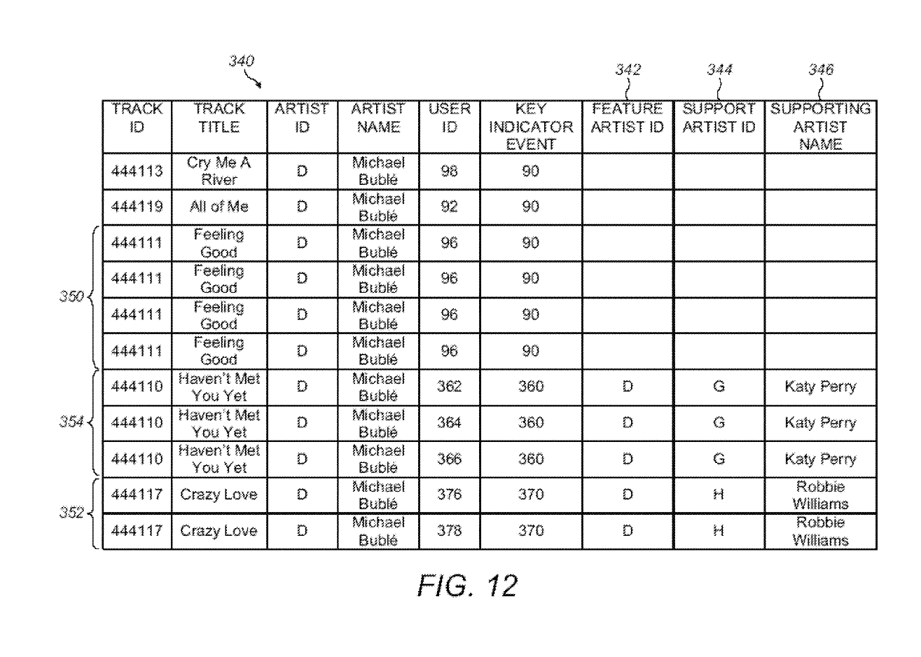

FIG. 12 is a table showing results of a user request of digital media content pool with an analysis extending the digital media content pool to include a tertiary marker in accordance with an embodiment of the invention;

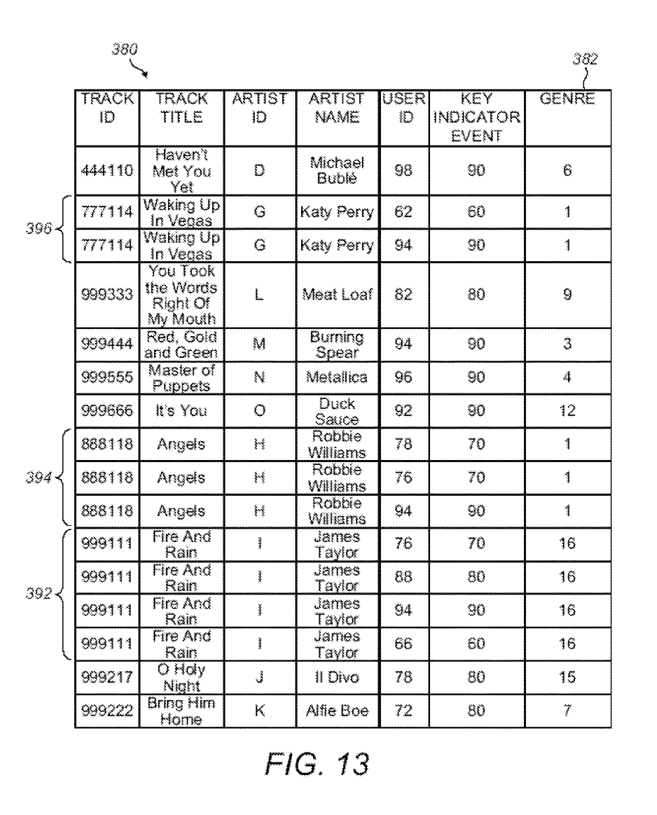

FIG. 13 is a table showing results of a user request of digital media content pool with an analysis extending the digital media content pool to include a tertiary marker in accordance with an embodiment of the invention;

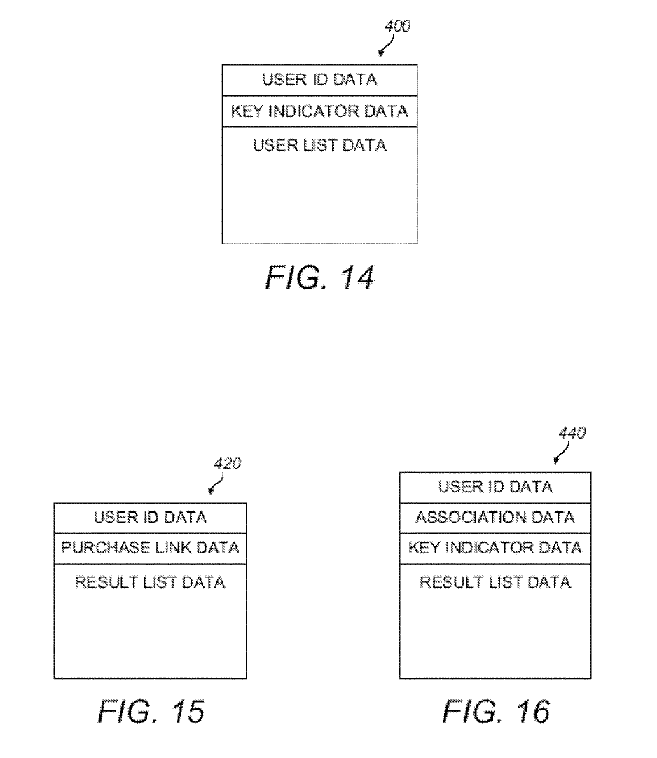

FIG. 14 illustrates schematically user data transmitted from user device to server in accordance with an embodiment of the invention;

FIG. 15 illustrates schematically results data transmitted from server to user device;

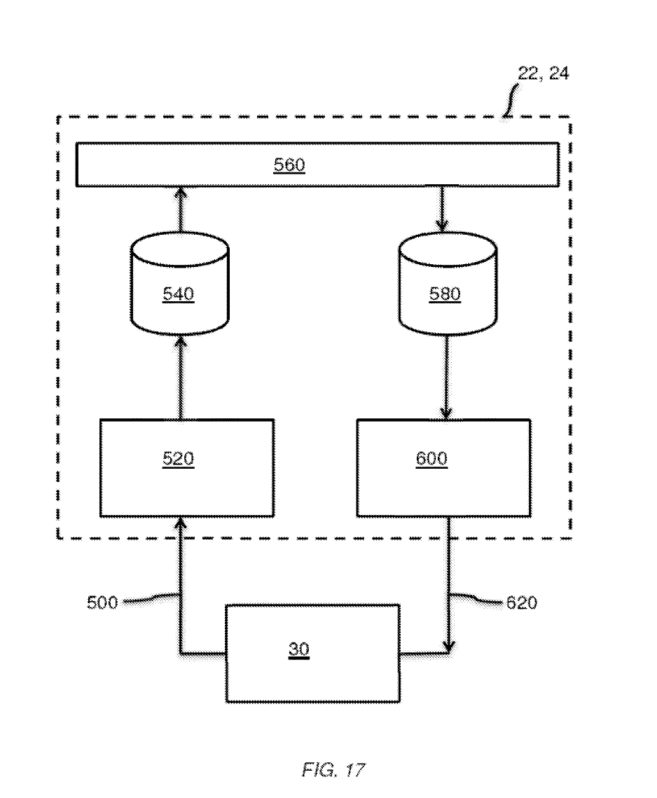

FIG. 16 illustrates schematically results data transmitted from server to user device; and

FIG. 17 illustrates a schematic block diagram of a configuration of the server in accordance with an embodiment of the invention.

### MODE FOR THE INVENTION

### Mode for Invention

FIG. 1 illustrates a schematic block diagram 10 overview of a network for associated user digital media content distribution in which a digital media content pool apparatus and method may be implemented in accordance with an embodiment of the invention. As illustrated, the main components are interconnected via a network such as the internet 20. The main components comprise a server 22, a digital media content store 24, at least one user device 30, and at least one user digital media content player 32. The user device may be a computer, an internet protocol (IP) enabled set-top box, or the like. The user device may be any digital media content player such as a MP3 player, MP4 player associated with the user device. The user device and/or the user player may be in communication with the server via the internet. The connection may be a wired or wireless connection. It will be appreciated that in an embodiment the user player and/or the user device may be present without the other. The media store may be a separate server or may be provided at the server. The media store may comprise a plurality of media stores.

FIG. 2 illustrates a representative schematic block diagram 50 of data acquisition of associated user digital media content within the network shown in FIG. 1 in accordance with an embodiment of the invention. The media store may be configured as shown with a first association pool 60 arranged with digital media content from user players 62-68, a second association pool 70 arranged with digital media content from user players 72-78, a third association pool 80 arranged with digital content from user players 82-88, and nth association pool 90 arranged with digital content from user players 92-98.

FIG. 3 illustrates a representative schematic block diagram 100 of a server within the network shown in FIG. 1 in accordance with an embodiment of the invention. The server 22 comprises a server processor 102, server memory 104, server interface 106, input device 108, and output device 110. The server further comprises a server registration module 120, media store module 122, analysis module 124, server result module 126, and server request module 128.

FIG. 4 illustrates a representative schematic block diagram 130 of a user device within the network shown in FIG. 1 in accordance with an embodiment of the invention. The user device comprises a user device processor 132, user device memory 134, user device interface 136, input device 138, and output device 140. The user device comprises a registration module 150, playlist module 152, user request module 154, and user result module 156. It will be appreciated that the user player may be arranged with the components of the user device shown in FIG. 4.

FIG. 5 illustrates a method 170 of a digital media content user associated pool system in accordance with an embodiment of the invention. The interaction between the user device and the server is shown in FIG. 5. The user accesses the registration module on the user device to register with the system to perform a user registration 172 process. The server then registers the user 174 and associates the user with a key or primary association indicator such as an event that the user has attended or plans to attend. The user is then able to elect whether or not the user's digital media content is to be included or to participate in the pool 176. If the user decides to allow the user content to be included in the pool, the user digital media content data is extracted 178 from the user device, and the digital media content data is transferred 180 to the server. The user content is stored/updated 182 in the media store of the server. Upon a user request 184, the digital media content data of the user's individual library may be updated in the server 186. If the user updates the content, the user content is extracted 178 and the user content is transferred to the server 180. The user request is then transmitted 188 to the server and the server processed 190. The results may be stored and tracked on the individual user device 192 and the like. The results are transferred to the user device 194 and the results are stored 196,

The items of user content may comprise digital media content data such as playlists, media libraries, video files, audio files, image or graphic files, and the like. It will be appreciated that items of such digital media content data may comprise additional features, details, information or the like such as meta-data, meta-information or the like. For example, digital media content data relating to audio files may comprise additional features, information and the like such as for example artist name, track name, date of track, recording label name, genre, or the like in addition to the audio track. For example, digital media content data relating to playlists, digital content managers, or the like may comprise additional details, elements, or the like such as for example track playcount, purchase date, source of purchase, purchase date, date of each play, or the like. Such meta data, meta-information or the like may be stored in the media store of the server and/or the user device.

FIG. 6 illustrates a method 200 of a module of the user device of FIG. 5 in more detail in accordance with an embodiment of the invention. The user accesses the registration module 202 to enter the user details 204 and the key indicator that the user is affiliated 206, such as a concert that the user attended of a specific artist, a particular brand that a user likes, or the like. The user also has an opportunity to enter additional secondary associations 208 such as other concerts that the user attended of a specific artist, another particular brand that the user likes, or the like. The user then decides whether to contribute the user's digital media content data to the pool 210 on the media store. The user may then also decide whether to permit the personal details of the user 212, such as name, contact details, and the like, to be revealed to other users. Once registered, the user then is able to compile a request 214 for a search. In compiling the request, the user is able to update the user digital media content data 216 in the media store prior to submitting the request 218.

FIG. 7 illustrates a method 230 of a registration and analysis module of the server of FIG. 5 in more detail in accordance with an embodiment of the invention. The server receives the request 232 and identifies user ID and associated key indicator event pool 234. The module receives and identifies the objective and relevant context of the user search request 236. The relevant context is the perimeter, boundary, objective or the like of the search parameters of the search request based on the user primary association indicator. The association indicator is used to associate digital media content data in the expert pool that is from users that have an association indicator in common. The search request specifies the relevant context and/or type of content that is being requested, and the key indicator defines the extent of the digital media content data within the pool stored in the media store from which the search results are drawn. The format of the search request may contain parameters of the search by which to search the digital media content data of the media store. Key indicators of the primary association indicator may include details of the event, such as a concert and the like, artist name, date, venue, and the like. The analysis module identifies the search primary marker 238 and determines if a sufficient result is achievable from the event pool 240. If it is sufficient 240, the analysis module generates the results 248 and transfers 250 and stores 252 the results to the user requesting the search. The results may then be tracked 254. If the event pool is not sufficient to provide a meaningful result, then the event pool is expanded by extending the event pool to include secondary markers 242 in addition to the primary marker. If it is sufficient 244, the analysis module generates the results 248 and transfers the results to the user requesting the search. If the event pool is not sufficient to provide a meaningful result, then the event pool is expanded by extending the event pool to include tertiary markers 246 in addition to the primary and secondary markers. It will be appreciated that if the event pool is not sufficient it may be possible to include additional tertiary markers.

In some embodiments where the event pool is too large to enable a meaningful result to be achieved, the size of the event pool may be contracted by reference to one or more sub-group markers for a user and a meaningful result attempted from the data of the event pool associated with the one or more sub-group markers. The sub-group markers may be arranged in a hierarchy whereby they comprise a primary sub-group marker followed by a secondary sub-group marker and so on, each sub-group marker in a series comprising a subset of the data of the previous sub-group. A sub-group marker may be defined by any of a number of user selected characteristics including time-based characteristics. For example, a sub-group marker may be selected as most played media in the last x minutes where x is a specified time period in the user sub-group marker. A sub-group marker may comprise a plurality of characteristics in combination as a means of greatly reducing the size of a very large event pool in a small number of iterations, even only one iteration.

According to embodiments, the first time the user connects to the server they agree to download the user application to their user device. However, the user application may also be provided to the user for application to the user device through other means, such as the user application may be provided for a storage device for transfer to the user device. In another embodiment, the user application is provided on a storage medium alongside content for consumption by the user, for example, on a music CD, DVD, or the like. The user application comprises an interface to the user's device and the application comprises a playlist or library module that is capable of locating user files on the user device and extracting items of user digital media content data from the user files. The extracted user data can be stored at memory 134 prior to transfer to the server 100 via the communication interface 136. In one example, the user files are music files and the playlist module extracts user music data from the user music files. Each music track may have its own music file.

Once registered, the user is able to send requests 184 to server. The user may also be asked to update user content 186. If the user decides to update the user content data on store at the media store, the digital media content data is extracted 178 from the user device, and the digital media content data is transferred 180 to the server. The user content is stored/updated 182 in the media store of the server. It will be appreciated that the user content may be stored/updated at different times, for example upon registration, upon each request, at other predefined times, whenever the user changes, adds, removes, or the like content from the user's playlist or digital media content data library or the like. The user's request is transferred 188 to the server, and the server processes 190 the user's request. Once processed, the results are tracked 192 and transferred 194 to the user device and the user device may store 195 the results once received. The user search request and search results may be tracked to build up a user profile and track links and trends between digital media content data of associated users. The results and user libraries are stored in the media store. In tracking the results and user libraries uploaded at different times to the media store, trends may be derived to influence future results by determining how meaningful the results are to the users. For example, to avoid returning repetitive results to the same user's search requests, the recency factor may be weighted of the last time a certain track was provided in a search result. If for example the track is a track that was recently listed in a recent search result, then it is less likely to be listed in a new search result. In another embodiment the ownership and playcount of the tracks listed in a search result are compared in the user library data to determine if the user increased the playcount of the track after receiving the search result or track recommendation. In another embodiment, if the track recommended in the search result was not in the user's library, i.e. the user did not own the track in their library, it can be determined if the user has since purchased and played the recommended track.

It will be appreciated that the request may be sent under different circumstances. For example, the request may be automatically generated by the system and sent to the user after a specific user action on the user device, such as for example playing specific digital media content such as a particular audio track, attending a particular event, purchasing a particular audio track, or the like. The search request may be generated based on the tracked results of the user search results and trends. In another embodiment, a search result may be automatically generated in the server by the server request module in response to changes in the dynamically changing pool of digital media content of the media store.

It will be appreciated that the registered user may register one event or affiliation as their main affiliation and their user data as a single premiere or main event, and associate their user data with any number of other auxiliary or secondary associations or associated events. The user may be able to change their main premiere event registration. The user data may be shared with the event pool for the main event pool and the associated event pools. The user selects a primary event to against which the context is made against the association indicator for a meaningful result generation. The user can then view the results from other events or change their primary event if required. The user may change or indicate a new main primary event or association indicator at any time after registration.

In an embodiment the user application transfers user digital media content data to the server upon first connection and registration. Upon second and subsequent connections to the server, the user digital media content data may or may not be transferred. It is possible to transfer data regarding changes to the user library to be transferred to the server upon second and subsequent connections. The media store module 122 may receive and store the user digital media content data in memory 104. The media store module compares the received user data with the stored data to determine if there are any changes, such as additions or deletions of any files. These changes are then stored to be transferred to the server. The comparison of changes may be done at either the server, user device, or the like.

In an embodiment, not all the user file content is transferred. It will be appreciated that user digital content data may include for example, the title of the music track, the artist of the track, the album to which the track belongs, genre of the track, and the like. Therefore, in some embodiments, it will be appreciated that it is not necessary to transfer all the content of each user file, such as the track, and the like. Transfer times between user device and server can be optimized when only the relevant content of the user file is transferred.

User music data can be retrieved through an application programming interface (API) of music library software, such as WINDOWS MEDIA PLAYER, WINAMP MEDIA PLAYER, ITUNES, and the like, provided at the user device 30. WINDOWS MEDIA PLAYER is a trademark of Microsoft Corporation of Redmond, Wash., United States of America. WINAMP MEDIA PLAYER is a trademark of America On Line of New York, N.Y., United States of America. ITUNES is a trademark of Apple Inc. of Cupertino, Calif., United States of America. The music library may also store music files as XML and binary files so that user music data may be retrieved directly rather than via the API. User music data may also be retrieved directly from the metadata of each music file. Typically metadata contains information such as the name of the track, the name of the artist, the title of the album to which the track belongs, the number within the album tracklisting, genre of the track, the year of the track, the file name, the file size, the duration of the track, the sample rate of the track, the beats per minute of the track and the rating, and the like. However, other data may be contained within the metadata and any combination of the above information can be retrieved and transferred to the server. Likewise, the data sent in the search results from the server to the user device may comprise other data that may be contained within the metadata and any combination of the above information can be retrieved and transferred.

A system for automatically generating a playlist of digital audio tracks by accessing a user's existing digital audio track libraries that are arranged by artist, title, date, genre, etc., is described in international patent application PCT/GB2008/00391, published 20 Nov. 2008 as international publication WO2009/090358, the entire content of which is incorporated herein by reference.

In an embodiment, a user may have uploaded music files to their music library from compact discs (CD). Not all CDs provide metadata for each track, and in this instance one or more track data, metadata for the track, and any desired further track data can be retrieved from a general music database, such as from a third party music library, such as provided by ITUNES, based on the CD's identifier.

In an embodiment, the server is able to identify the user from the registration process based on one or more of hardware device ID, serial number of the user device or user player, user log-on ID (for a computer), media access control (MAC) address, or the like. The user identity is transferred to the server together with the digital media content data, playlist data, and the like. The user identifier can be any form of unique number/letter combination which is associated with the user such that all data received from the same user device, user player, or the like, is reconciled with the same user records of the server. The user identifier may be transferred to the server at the beginning or the end of each data stream. Upon receipt of the data stream, the server processes the user digital media content data.

In an embodiment the request comprises the type of content and the key indicator. A key indicator may be events such as concerts, festivals, performances, and the like. The association may also be for example members of a fan club, group, company, organization, brands, sports team, school, geographical areas, age, gender, and the like. For example, a key indicator may be events such as Beyonce at the Manchester Arena on 25 Feb. 2014, JLS at the Manchester Arena on 14 Dec. 2013, or the like. Examples of the types of content in a request are, ‘top 20 tracks of the primary artist for the event owned by people attending the event’, ‘top 20 tracks not of the primary artist for the event owned by people attending the event’, ‘top 20 tracks of the primary artist for the event played by people attending the event’, ‘top 20 tracks not of the primary artist for the event played by people attending the event’, or the like. The requester could be in the form of an application, web browser, or the like, and the format of the request and results may be presented in JSON, XML, or the like, via a SOAP interface, REST interface or the like. The parameters of the request may include the: key indicator defining the event pool of associated user digital media content data; a user identifier to identify the user making the request; the content type identifier; a flag that states if the user wishes their digital media content data to be included and participate in the event pool.

If the event pool is of sufficient size the results may be provided from searching the event pool with primary markers or association indicators. For example, a sufficient size may be for example 100 members, and sufficient quality is each member having at least 10 items of digital media content data. If the pool is of insufficient size or quality to fulfil the request, then the control function uses secondary markers or tertiary markers to extend the pool to supplement the pool to provide adequate results. Secondary and tertiary markers or association indicators identify users who are not members of the event pool, but that are related to the pool in some way and whose information can reliably be used to supplement the event pool in order to provide results of sufficient quality.

In an embodiment, if the quality controls for the specific search request function determine that number of users required is below the threshold determining whether the event pool would be adequate, e.g. 100 users, then at least (100−number of users in the pool) are added to the pool based on secondary markers and tertiary markers. The results are then determined from the expanded pool of users.

As the pool of users registered in an event pool attend a common event, it is likely that the user data forming the event pool provides meaningful results to the requesting user. If the user data is not sufficient to provide a result, secondary markers and/or tertiary markers are used to broaden the expert pool. The secondary markers and/or tertiary markers may be selected on the basis of providing the most likely to provide the most meaningful results. For example, a user may indicate a primary marker as a concert of one artist, such as a Beyonce concert, then the secondary markers may be other artists that are or have been support acts for the primary artist in the concert or previous concerts or events. In another embodiment, the secondary or tertiary artists may be derived automatically from pre-known or derived information such as the genre of artist, known associated artists, for example Beyonce is married to Jay-z, so therefore, Jay-z may be a standard secondary or tertiary marker for a Beyonce concert. In another embodiment, the digital media content of the user libraries may be analyzed to derive that of the attendees of the primary maker concert may have relatively substantial proportion in their library of another artist's tracks that would make that artist a strong tertiary marker to provide meaningful results to the user search request.

FIG. 8 is a table 260 showing results of a user request for digital media content data of an artist associated to the pool including a primary marker analysis in accordance with an embodiment of the invention. The primary marker column 262 shows the main key indicator event 60 of the Wet Wet Wet convert of the Phones4U Arena 8 Dec. 2013 as the basis for the event pool. The users 62,64,66,68 that registered with the system have indicated that they are attending the event. For example, a user may indicate they have attended or may be attending a music event, festival or the like, of a particular artist. The key indicator event, or primary marker may be an event that users or attendees may be attending such as a music event, concert, festival, or the like. It will be appreciated that the key indicator event may be a group, society, company, club, school, university, or the like, that users or members may belong. The search results shown in the table of FIG. 8 are results from a search performed within the event pool, such as for example, ‘the top three tracks of the primary artist for the event owned by people attending the event’. The top digital media content, i.e. top track 270 is shown as track ID 111110 ‘Love Is All Around’ to artist A, Wet Wet Wet, as this track is owned by at least four users in the event pool, i.e. users 62,64,66,68. The second track 272 is track ID 111118 ‘Hold Back The River’ to artist A, Wet Wet Wet, as only three users 62,64,66 owned this track. The third track 274 is track ID 111114 ‘With A Little Help From My Friends’ to artist A, Wet Wet Wet, as only two users 64,66 owned this track. The other tracks shown in the table are only owned by one user, and not in the top three tracks. It will be appreciated that the search request may include any number of tracks, for example three, twenty, hundred, or the like.

FIG. 9 is a table 280 showing results of a user request for digital media content of an artist not associated to the pool within a primary marker analysis in accordance with an embodiment of the invention. The search results shown in the table of FIG. 9 are results from a search performed within the event pool with users 72,74,76,78 attending the key indicator event 70 JLS concert at the Phones4U Arena on 14 Dec. 2013. The user request for this result is, ‘the top three tracks of any artist other than the primary artist for the event owned by people attending the event’. The top digital media content of the search result ranking is top track 290 ‘Rock Your Body’ is shown as track ID 555110 to artist E, Justin Timberlake, and owned by users. Track 290 is owned by at least four users in the event pool, i.e. users 62,64,66,68. The second track 292 ‘Forever Love’ is track ID 666117 to artist F, Gary Barlow, is owned by three users 64,66,68. The third track 294 ‘Sexy Back’ is track ID 555119 to artist E, Justin Timberlake, is owned by two users 64,66.

FIG. 10 is a table 300 showing insufficient results of a user request of digital media content of an artist associated to the pool 80 with an analysis including a primary marker in accordance with an embodiment of the invention. The search results shown in the table of FIG. 10 are results from a search performed within the event pool 80, such as for example like the search performed with respect to FIG. 8 above, i.e. ‘the top three tracks of the primary artist for the event owned by people attending the event’. In this embodiment the event pool comprises users 82,84,86,88 attending key indicator event 80 for Artist C, Boyzone at the Phones4U Arena on 25 Feb. 2014. The search of the pool 80 digital media content data has provided only the top track 310 ‘No Matter What’ as track ID 333114 to artist C, Boyzone, as four users 82,84,86,88 owned this track within key indicator event 80. The event pool 80 did not return results for the second and third tracks as there was insufficient digital media content data. Accordingly, the event pool is broadened to include secondary markers.

FIG. 11 is a table 320 showing results of a user request of digital media content pool with an analysis extending the digital media content pool to include a secondary marker in accordance with an embodiment of the invention. Secondary marker 322 shown as key indicator column expands the pool 80 by including other key indicator events in other event pools such as 60,70,90. As the search conducted for FIG. 10 within event pool 80 did not comprise sufficient data to provide results for the second and third tracks, data from other event pools are included in the search, such as event pool 60 with user data associated with Artist A, Wet Wet Wet; event pool 70 with user data associated Artist B, JLS; event pool 90 with user data associated with Artist D, Michael Bublé. With the additional user data, a second track 332 ‘Picture of You’ track ID 333113 to artist C, Boyzone, from data from event pool 60,70,90, and a third track 334 ‘Love Me For A Reason’ with track ID 333115 to artist C, Boyzone, from data event pool 70,90. The second track 332 ‘Picture Of You’ is owned by users 64,74,94 that attended the Wet Wet Wet, JLS, and Michael Bublé concerts, respectively. The third track 334 ‘Love Me For A Reason’ is owned by users 76,96 that attended the JLS and Michael Bublé concert events, respectively.

FIG. 12 is a table 340 showing results of a user request of digital media content pool with an analysis extending the digital media content pool to include a tertiary marker 342 in accordance with an embodiment of the invention. Tertiary marker 342 as shown is an affiliated supporting artist that is also included in the search to expand the pool. Other tertiary markers may also be included to dynamically expand the pool of digital media content in a meaningful manner. For example, a tertiary marker may be any association between artists such as another artist within the same genre, country, state, era, decade, year, recording label, instrument, or the like.

In this embodiment shown in FIG. 12, the tertiary marker is the supporting artists Katy Perry and Robbie Williams that have been associated as the support act for the feature artist Michael Bublé. The columns show the tertiary markers of association between the feature artist D, Michael Bublé, and the support artists 344,346 G, Katy Perry, and H, Robbie Williams. For example, the feature artist is Michael Bublé, and the top track 350 is ‘Feeling Good’ with track ID 444111 from all users within pool 90. However, there were not enough results in pool 90 to yield a meaningful result for the second and third track. Therefore, the expert pool 90 is extended to include any tracks identified by users 360,364,366,376,378 having any tracks from artists that were supporting acts for the feature artist, for example Katy Perry and Robbie Williams. By extending the expert pool to include tertiary markers, the search included further songs to provide a meaningful result to the requesting user. The second track 354 is ‘Haven't Met You Yet’ with track ID 444110, to artist Michael Bublé owned by users 362,364,366 of key indicator event 360 associated with support artist Katy Perry. The third track 352 ‘Cry Me A River’ with track ID 444118.

FIG. 13 is a table 380 showing results of a user request of digital media content pool with an analysis extending the digital media content pool to include a tertiary marker in accordance with an embodiment of the invention. The tertiary marker 382 shown is genre, such as, 1=pop, 2=R&B/soul, 3=reggae, 4=heavy metal, 5=classical, 6=jazz, 7=theatrical/operatic, 8=hip hop/rap, 9=rock, 10=country/western, 11=blues, 12=dance, 13=disco, 14=alternative, 15=holiday, 16=folk, 17=world, etc. In this search with results shown in FIG. 13, the search objective is, ‘the top three tracks of a different artist other than the main artist of the event pool from another genre owned by people attending the event’. The results show that event pool 90 associated with artist D, Michael Bublé, is insufficient in providing three tracks in the results, based on Michael Bublé genre classification for the track ID 444110, ‘Haven't Met You Yet’ as 6=Jazz. The event pool 90 includes some results and is extended by the tertiary marker 382 to include other event pools 60,70,80 associated with user data attending other events of artists A,B,C. The user data shows that the top track with the event pool expanded is top track 392 with track ID 999111, ‘Fire and Rain’ by artist I, James Taylor in genre 16=folk, owned by users 66,76,88,94. The second track 394 is track ID 999118, ‘Angels’ by artist H, Robbie Williams in genre 1=pop, owned by users 76,78,94. The third track 396 is track 7771148 by artist G, Katy Perry in genre 1=pop, owned by users 62,94. The table 340 shows that the tracks selected are in different genre from Michael Bublé's ‘Haven't Met You Yet’.

It will be appreciated that search results within the dynamic expert pool of digital media content may be based on other factors that are weighted in addition to or instead of the number of tracks owned by users. For example, other factors such as recency, frequency, ubiquity, or the like may be considered to prioritize tracks within the search results to provide more meaningful results to the user. Recency is a factor based on how recent the user played the digital media content. Frequency is a factor based on how often the user played the digital media content. Ubiquity is a factor based on the prevalence or popularity the digital media content. For example, the number of tracks by each artist in a user's playlist in their library may be combined with the playcount of those artists so that it can be determined whether the artist is actually significant to the user. For example, if a user has a particular artist in their digital media content data, but never actually lists to tracks by this artist, then it is determined that this artist may not be as significant to the user, as if the playcount was higher. It will be appreciated that the weighting factors may be applied or taken from within each individual user's playlist and/or across the pool of primary, secondary, and/or tertiary markers.

The user data used for weighting factors in prioritizing search results is obtained from the user library content that is uploaded to the media store at the time of registration. As the digital media content in each user library may change from the time of registration, the digital media content may be uploaded to update the media store. The digital media content of the user library may be uploaded to the media store at different times, for example after a predefined time, such as for example every month or the like. In another embodiment, the user library may be uploaded to the media store each time the user submits a search request, or the like.

As the content of the user library is stored in the media store at registration and at each upload, or the like, the user library can be tracked and comparisons of the digital media content of the user library at the different upload times may be used for predictive and descriptive analysis in light of any search results provided earlier within the system. Also, it may be derivable from the user library if the digital media was purchased or pre-owned prior to user registration with the system or prior to receiving search request, as well as other information of the digital media content such as the source and date of purchase, purchase value, and the like. Accordingly, the tracking of the digital media content and the user activity within the user library of recency, frequency, ubiquity and other such factors are derivable at the time of registration, at the time of a search request, and before or after a search request when the user library digital media content data is uploaded and stored in the media store.

Tracking the user library activities at the time of a search request and subsequently, also enables the strength of the association between primary, secondary and tertiary markers or factors.

FIG. 14 illustrates schematically user data 400 transmitted from user device to server in accordance with an embodiment of the invention showing user ID data, key indicator data and user list data.

FIG. 15 and FIG. 16 illustrate schematically results data 420,440 transmitted from server to user device. FIG. 15 shows the results data in one format comprising user ID data, purchase link data, and result list data. The purchase link data is information for purchasing the listed digital media content. FIG. 16 shows the results data in one format comprising user ID data, association data, key indicator data, and result list data. The results data may also include association data, key indicator data, and tertiary data and may reveal the details of the user associated with the listed user data if the user permission is obtained to be shared with the requesting users. Identifying the user data details may allow users that have similar musical tastes and interests to contact each other. For example, users that have the same primary markers or key indicators, such as users attending the same music concert, may have similar tastes and interests and may therefore be inclined to contact each other. It will be appreciated that the data transmitted to and from the server may comprise additional content such as for example weighting factors and the like, such as individual user library statistics, cross pool statistics, such as frequency, recency, ubiquity, or the like.

FIG. 17 depicts an arrangement of a user device 30 and server 22 whereby the server 22 is configured to determine potential meaningful results for a user of the system without first requiring a request from the user. It will be understood that there is a finite number of requests that any user of the system of the invention can validly make. Furthermore, where there are a large number of users making requests at about the same time, this can place a huge burden on the processing capacity of the system. In order to alleviate processing bottlenecks, the server 22 can be configured to analyse for each user of the system valid requests the users mighty make and pre-compute meaningful results for such requests in readiness to deliver one of such results to a user in response to a user request containing an appropriate one of the finite number of valid requests. In some instances, a pre-computed result may not comprise a completely meaningful result for a specific user request, but such result may be a closely matched result which needs little additional processing to complete it. The server so configured processes potential results for users during periods of low processing demand.

The arrangement of the system depicted in FIG. 17 comprises the server 22, possibly combined with the media store 24, in communication across the network with the user devices 30. Only one user device 30 is shown for reasons of convenience. Logically, the server 22 is configured with a feed input or pipeline 500 from the user device 30 for receiving raw event data such as track listens. The server 22 is configured with an event tracking module 520 to process said raw event data from users. The raw event data is passed from the event tracking module 520 to a first database 540 for storing raw event data in a persistent format. A event processing module or pipeline 560 is fed raw event data from the first database 540. The event processing pipeline 560 processes pre-set questions of the user pools that a user of a device 30 belongs to and determine which have the most meaning for the user. Processed results from the event processing pipeline 560 are stored in a second database 580 for storing processed results. A request handler module 600 retrieves results from the second database 580 in response to user requests thereby removing real-time processing burden on the server 22. A separate results output or pipeline 620 connects the request handler module 600 back to the user device 30.

The digital media content data discussed in the embodiments is audio tracks for ease of discussion and illustrative purpose, however, it will be appreciated that the digital media content data making up the pool of media content may take different forms such as audio, image, graphic, animation, video, multimedia, combinations thereof, and the like. For example, files may be in the format of uncompressed such as for example wave audio format (with filename extension WAV), lossless such as for example free lossless audio coder-decoder (CODEC) format (with filename extension FLAC), lossy such as for example moving picture experts group (MPEG)-1 or MPEG-2 audio layer III (with filename extension MP3) or the like. The digital media content format may take any number of other formats in addition to WAV, FLAC, or MP3, such as advanced audio coding format (with filename extension AAC) windows media audio format (with filename extension WMA), matroska format (with filename extension MKV), joint photographic experts group (with filename extension JPEG), MPEG-4 format (with filename extension MP4), or the like.

The methods and apparatus described may be implemented at least in part in software. Those skilled in the art will appreciate that the apparatus described may be implemented using general purpose computers or using bespoke equipment. The hardware elements, operating systems and programming languages of such computers are conventional in nature, and it is presumed that those skilled in the art are adequately familiar therewith. Of course, the server functions may be implemented in a distributed fashion on a number of similar platforms, to distribute the processing load.

Aspects of the methods and apparatus described herein can be executed on a mobile station and on a computing device such as a server. Program aspects of the technology may be thought of as ‘products’ or ‘articles of manufacture’ typically in the form of executable code and/or associated data that is carried on or embodied in a type of machine readable medium. ‘Storage’ type media include any or all of the memory of the mobile stations, computers, processors or the like, or associated modules hereof, such as various semiconductor memories, tape drives, disk drives and the like, which may provide storage at any time for the software programming. All or portions of the software may at times be communicated through the Internet or various other telecommunication networks. Such communications, for example, may enable loading of the software from one computer or processor into another computer or processor. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to tangible non-transitory ‘storage’ media, terms such as computer or machine ‘readable medium’ refer to any medium that participates in providing instructions to a processor for execution. As mentioned, the user device may be any device such as a mobile telephone, tablet, MP3 player, a lap top computer, a personal digital assistant (PDA), or the like which is provided with a communication interface and music playing capabilities with any type of communication capability such as wireless, WiFi, WiMax, third generation mobile technology (3G), fourth generation mobile communication technology (4G), or the like.

Hence, a machine readable medium may take many forms, including but not limited to, a tangible storage medium, a carrier wave medium or physical transmission medium. Non-volatile storage media include, for example, optical or magnetic disks, such as any of the storage devices in any computer(s) or the like, such as may be used to implement the data aggregator, the customer communication systems, etc. shown in the drawings. Volatile storage media include dynamic memory, such as main memory of such a computer platform. Tangible transmission media include coaxial cables; copper wire and fiber optics, including the wires that comprise a bus within a computer system. Carrier-wave transmission media can take the form of electric or electro-magnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD OR DVD-ROM, any other optical medium, punch cards paper tape, and other physical storage medium with patterns of holes, a RAM, a PROM and EPROM, a FLASH-EPROM, any other memory chip or cartridge, a carrier wave transporting data or instructions, cables or links transporting such a carrier wave, or any other medium from which a computer can read programming code and/or data. Many of these forms of computer readable media may be involved in carrying one or more sequences of one or more instructions to a processor for execution.

Those skilled in the art will appreciate that while the foregoing has described what are considered to be the best mode and, where appropriate, other modes of performing the invention, the invention should not be limited to specific apparatus configurations or method steps disclosed in this description of the preferred embodiment. It is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings. Those skilled in the art will recognize that the invention has a broad range of applications, and that the embodiments may take a wide range of modifications without departing from the inventive concept as defined in the appended claims.

1. A digital media content pool apparatus comprising:
a communication interface arranged to receive digital media content data from a plurality of user devices;
a digital media store for storing the digital media content data from the plurality of user devices in one or more digital media content pools;
a registration module for configuring the digital media content data in one or more of the digital media content pools according to an association marker representing an association between at least two users; and
an analysis module for generating a search result of the digital media content data in one or more of the digital media content pools based on a relevant context of the user digital media content data associated with the association marker and the type of content requested and information associated with the user of a requesting user device.

2. The digital media content pool apparatus according to claim 1 wherein a search request is generated in response to a user action on a user device.

3. The digital media content pool apparatus according to claim 2 wherein the user action comprises playing a specific digital media content data.

4. The digital media content pool apparatus according to claim 1 wherein a search request is generated in response to a change in the digital media content data of the digital media store.

5. The digital media content pool apparatus according to claim 1 wherein a search request is generated in response to a change in the digital media content data of the user device.

6. The digital media content pool apparatus according to claim 1 wherein the association marked comprises a music concert event.

7. The digital media content pool apparatus according to claim 1 wherein the registration module is arranged to configure the digital media content data according to a plurality of association markers.

8. The digital media content pool apparatus according to claim 7 wherein the plurality of association markers comprise a primary association marker being associated with users having an association marker in common with the user in which the search is based.

9. The digital media content pool apparatus according to claim 7 wherein the plurality of association markers comprise a secondary association marker wherein the secondary association marker comprises at least one association marker different from the primary association marker.

10. The digital media content pool apparatus according to claim 7 wherein the plurality of association markers comprise a secondary association marker being associated with users having an association marker uncommon with the user in which the search is based.

11. The digital media content pool apparatus according to claim 7 wherein the plurality of association markers comprise a tertiary association marker being associated with a feature of the digital media content data in common with the relevant context of the requested digital media content data of the user in which the search is based.

12. The digital media content pool apparatus according to claim 11 wherein the feature of the digital media content data comprises the genre of the requested digital media content data.

13. The digital media content pool apparatus according to claim 11 wherein the feature of the digital media content data comprises a support artist of the artist of the requested digital media content data.

14. The digital media content pool apparatus according to claim 11 wherein the plurality of association markers comprises at least one primary association marker, at least one secondary association marker, and at least one tertiary association marker.

15. The digital media content pool apparatus according to claim 1 wherein the search result comprises user details associated with the digital media content data.

16. The digital media content pool apparatus according to claim 1 wherein the digital media content data from the user device is updated and stored in the media store in response to a registration of a user.

17. The digital media content pool apparatus according to claim 1 wherein the digital media content data from the user device is updated and stored in the media store in response to a search request.

18. The digital media content pool apparatus according to claim 1 wherein the digital media content data from the user device is updated and stored in the media store in response to a change in the digital media content data on the user device.

19. The digital media content pool apparatus according to claim 1 wherein the search result is stored in the media store and compared with another previous search result stored in the media store associated with the user in which the search is based, and the search result is altered if the search result is identical to a previous search result.

20. The digital media content pool apparatus according to claim 1 wherein the digital media content data comprises features for tracking user actions corresponding with the digital media content data.

21.-45. (canceled)
